(19) United States
(12) Patent Application Publication
(10) Pub. No.: US 2007/0034569 A1
(43) Pub. Date: Feb. 15, 2007

(54) Backwash and cleaning method

(75) Inventor: Warren Thomas Johnson, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(73) Assignee: U.S. FILTER WASTEWATER GROUP, INC., Warrendale, PA (US)

(21) Appl. No.: 10/572,971

(22) PCT Filed: Sep. 22, 2004
(86) PCT No.: PCT/AU04/01292

§ 371 Date: Mar. 22, 2006

(30) Foreign Application Priority Data
Sep. 22, 2003 (AU) 2003905174

(51) Int. Cl. B01D 65/02

(52) U.S. Cl. 210/636; 210/650; 210/321.69; 210/321.88

(57) ABSTRACT

A method of concentrating the solids of a liquid suspension by providing a pressure differential across the walls of permeable, hollow membranes (6) immersed in the liquid suspension (9). The liquid suspension (9) is applied to the outer surface of the porous hollow membranes (6) to induce and sustain filtration through the membrane walls (12) wherein some of the liquid suspension passes through the walls (12) of the membranes (6) to be drawn off as clarified liquid or permeate from the hollow membrane lumens (11), and at least some of the solids are retained on or in the hollow membranes (6) or otherwise as suspended solids within the liquid (9) surrounding the membranes (6). The method includes periodically backwashing the membrane pores using the permeate by applying a gas at a pressure below the bubble point to the membrane lumens (11) to progressively displace at least some of the liquid permeate within the lumens (11) through the membrane pores resulting in removal the solids retained on or in the hollow membranes into the bulk liquid (9) surrounding the membranes (6).

### FIELD OF THE INVENTION

The present invention relates to concentration of solids in a suspension using hollow fibre membranes and, in particular, to an improved method of backwashing and chemically cleaning the hollow fibre membranes.

### BACKGROUND ART

Any discussion of the prior art throughout the specification should in no way be considered as an admission that such prior art is widely known or forms part of common general knowledge in the field.

Known backwash systems include those described in our earlier International Application No. WO93/02779 the subject matter of which is incorporated herein by cross-reference.

A pressurized liquid backwash of hollow fibre membranes has been found to be uneven along the length of the fibre membranes due to the frictional losses along the lumen. In membranes with the fibres closed at one end, the pressure of liquid is highest at the point of application of the pressurized flow to the fibres lumens and tapering off along the length of the membrane. This results in uneven backwashing and poor recovery of TMP at portions of the fibres remote from the backwash application point. In fibres open at both ends, the backwash flow is a minimum towards the centre of the fibre.

During chemical cleaning of membranes, cleaning solutions are often backflushed from the lumen side of the membrane to distribute the cleaning solution within the membrane fibre bundle. Applying the cleaning solution under pressure assists the removal of foulants from the surface. However, the limitations of pressure drop down the lumen during this step mean that achieving the same applied transmembrane pressure (TMP) to all areas of the membrane cannot be readily achieved, especially for small diameter fibres where the pressure loss is greatest. This impacts on the efficiency of cleaning.

### DISCLOSURE OF THE INVENTION

It is an object of the invention to overcome or at least ameliorate one or more of the disadvantages of the prior art or at least provide a useful alternative.

According to a first aspect, the present invention provides a method of concentrating the solids of a liquid suspension comprising:

(i) providing a pressure differential across the walls of permeable, hollow membranes immersed in the liquid suspension, said liquid suspension being applied to the outer surface of the porous hollow membranes to induce and sustain filtration through the membrane walls wherein:
(a) some of the liquid suspension passes through the walls of the membranes to be drawn off as clarified liquid or permeate from the hollow membrane lumens, and
(b) at least some of the solids are retained on or in the hollow membranes or otherwise as suspended solids within the liquid surrounding the membranes,
(ii) periodically backwashing the membrane pores using the permeate by applying a gas at a pressure below the bubble point to the membrane lumens to progressively displace at least some of the liquid permeate within the lumens through the membrane pores resulting in removal the solids retained on or in the hollow membranes into the bulk liquid surrounding the membranes.

This process ensures that the differential pressure applied during backwash is close to the gas pressure at the liquid interface as it travels down the lumen thereby ensuring that the maximum differential pressure is applied across the membrane wall at all points, although not simultaneously.

According to a second aspect, the present invention provides a method of concentrating the solids of a liquid suspension comprising:

(i) providing a pressure differential across the walls of permeable, hollow membranes immersed in the liquid suspension, said liquid suspension being applied to the outer surface of the porous hollow membranes to induce and sustain filtration through the membrane walls wherein:
(a) some of the liquid suspension passes through the walls of the membranes to be drawn off as clarified liquid or filtrate from the hollow membrane lumens, and
(b) at least some of the solids are retained on or in the hollow membranes or otherwise as suspended solids within the liquid surrounding the membranes,

(ii) dislodging the retained solids from the membranes by applying a dislodging medium through the lumens of said membranes while concurrently draining liquid from said lumens, wherein the application of the dislodging medium initially displaces liquid within the hollow membrane lumens through the hollow membrane with gas, to effect firstly a discharge of liquid in the lumens through the membrane walls, and secondly a transmembrane cleaning of the membranes by applying the gas at sufficient pressure onto the liquid to overcome the bubble point of the membrane, and ensure that the gas will displace liquid and follow it through the larger pores of the membranes to dislodge any solids retained therein; and for the emerging gas to scour the external walls of the membranes and displace the removed solids into the bulk liquid surrounding the membranes.

Preferably, said method is carried out as a continuous process utilising a repetitive cycle of solid accumulation and solid discharge.

According to a third aspect the present invention provides a concentrator for recovering fine solids from a liquid feed suspension comprising:

(i) a vessel for containing said feed suspension;

(ii) a plurality of permeable, hollow membranes within the vessel;

(iii) means for providing a pressure differential across walls of said membranes;

(iv) means for withdrawing clarified liquid from the membrane; and

(v) means for applying gas at a pressure below the bubble point to the liquid permeate in the membrane lumens to effect a discharge of at least some of the liquid permeate in the lumens through the membrane walls to dislodge any solids retained therein and displace the removed solids into the bulk liquid surrounding the membranes.

According to a fourth aspect the present invention provides a concentrator for recovering fine solids from a liquid feed suspension comprising:

(i) a vessel or tank for containing said feed suspension;

(ii) a plurality of permeable, hollow membranes within the vessel or tank;

(iii) means for providing a pressure differential across walls of said membranes;

(iv) means for withdrawing clarified liquid from the membrane; and

(v) means for applying gas pressure to the liquid in the membrane lumens and walls while the vessel or tank is exposed to atmospheric pressure and while concurrently draining liquid from said lumens, to effect firstly a discharge of liquid in the lumens through the membrane walls, and secondly a transmembrane cleaning of the membranes by applying the gas at sufficient pressure onto the liquid to overcome the bubble point of the membrane, and ensure that the gas will displace liquid and follow it through the larger pores of the membranes to dislodge any solids retained therein; and for the emerging gas to scour the external walls of the membranes and displace the removed solids into the bulk liquid in the vessel or tank.

Preferably, the backwash includes use of clean-in-place (CIP) chemical solutions as well as or instead of the filtrate. This may be employed in a number of different backwash methods.

One such backwash method includes filtering the chemical cleaning solution from the shell side, that is, from the outer surface or vessel side of the membrane into the membrane lumens. The normal backwash is then performed and the chemical solution forced back through the membrane pores in an even fashion by applying a gas as described above.

Another alternate form of chemical backwash includes backwashing initially with filtrate, that is, pushing the filtrate in a reverse direction through the membrane pores while injecting chemical cleaning solution into the filtrate. The filtrate/chemical solution mixture is then backwashed through the membrane by applying a gas as described above.

Yet another alternate form of chemical backwash includes applying chemical cleaning solution under pressure to the outer side of the membranes to force chemical cleaning solution through the membrane pores and fill the membrane lumens with the chemical cleaning solution. This is followed by the normal gas backwash described above.

In order to minimise the volume of chemical cleaning solution used all (or most) of the liquid in the system may be removed or drained from one side of the membrane, typically the filtrate side (or inside of the hollow membrane), then the outer side of the membrane is at least partially filled with chemical cleaning solution and a vacuum (or reduced pressure) applied to the filtrate side to cause the chemical cleaning solution to be drawn from the outer side of the membrane to the filtrate side, then gas pressure is applied to the filtrate side to force the chemical cleaning solution in the reverse direction from the filtrate side through the membrane wall back to the outer side of the membrane.

In another method, the filtrate side of the membrane(s) is drained or emptied of liquid and liquid on the outer side of the membranes is also partially drained or emptied. The outer side of the membrane lumen is then at least partially filled chemical cleaning solution. The chemical cleaning solution applied to the outer side of the membranes is then pushed through with gas (for a pressurized system) or drawn through under suction (for a submerged non-pressurized system) to fill the lumen with chemical cleaning solution and the volume of chemical cleaning solution used is less than the hold-up volume of liquid on the outer side of the membranes. Only enough volume of chemical cleaning solution on the outer side of the membranes to fill the membrane lumens is required. Pressure can then be applied to the lumen side to drain the chemical cleaning solution from the lumen by pushing it back through the membrane wall. This cycle can be repeated multiple times so that the chemical cleaning solution is alternately moved from one side of the membrane to the other through the membrane wall.

Each of the above chemical cleaning methods has been found to provide a more efficient chemical backwash. The methods allow for a minimal use of chemical cleaning solution while also enabling an enhanced washing process by providing a more efficient distribution of the chemical cleaning solution within the system. Desirably, these backwashes or cleans are performed on an intermittent basis.

Using the methods described the reverse flow cleaning step can be accomplished in such a way as to allow the transmembrane pressure (TMP) to be controlled by the gas pressure and to apply this TMP evenly along the membrane, even at the extremities from the lumen inlet. This ensures all areas of the membrane are contacted with chemical cleaning solution and that they are back-flushed with the same applied TMP. It also allows the chemical in the lumens to be fully drained by the end of the reverse flow step, which aids in recovery of chemical cleaning solution, reduces flushing requirements, and reduces cleaning downtime.

In one preferred form, the gas may be pulsed in its application to the membrane lumens. In one alternate form of the chemical solution backwash described above, the backwash is performed with the vessel empty.

The process can be applied to membranes submerged in an open vessel as well as pressurized membrane filtration systems.

### BRIEF DESCRIPTION OF THE DRAWINGS

Preferred embodiments of the invention will now be described, by way of example only, with reference to the accompanying drawings in which:

FIG. 1a shows a graph of transmembrane pressure (TMP) vs position along the membrane bundle of the membrane module configuration shown in FIG. 1b;

FIG. 1b shows a simplified sectional side elevation of a membrane module immersed in a feed liquid with pressurized liquid applied to the membrane lumens;

FIG. 2a shows a graph of transmembrane pressure (TMP) vs position along the membrane bundle of the membrane module configuration shown in FIG. 2b;

FIG. 2b shows a simplified sectional side elevation of a membrane module immersed in a feed liquid with pressurized gas applied to the membrane lumens;

FIG. 3a shows a graph of transmembrane pressure (TMP) vs position along the membrane bundle of the membrane module configuration shown in FIG. 3b;

FIG. 3b shows a simplified sectional side elevation of a membrane module immersed in a feed liquid with pressurized gas applied to liquid filled membrane lumens;

FIG. 3c shows an enlarged sectional view of the membranes in the indicated region of FIG. 3b;

FIG. 4a shows a simplified sectional side elevation of a membrane module with the feed liquid drained from around the module;

FIG. 4b shows an enlarged sectional view of the membranes in the indicated region of FIG. 4b;

FIG. 5a shows a simplified sectional side elevation of a membrane module with a lower portion of the module immersed in a chemical cleaning solution and suction applied to the membrane lumens;

FIG. 5b shows an enlarged sectional view of the membranes in the indicated region of FIG. 5a;

FIG. 5c shows an enlarged sectional view of the membranes in the indicated region of FIG. 5a;

FIG. 6a shows a simplified sectional side elevation of a membrane module with a lower portion of the module immersed in a chemical cleaning solution and pressurized gas applied to the membrane lumens; and

FIG. 6b shows an enlarged sectional view of the membranes in the indicated region of FIG. 6a.

### DESCRIPTION OF PREFERRED EMBODIMENTS

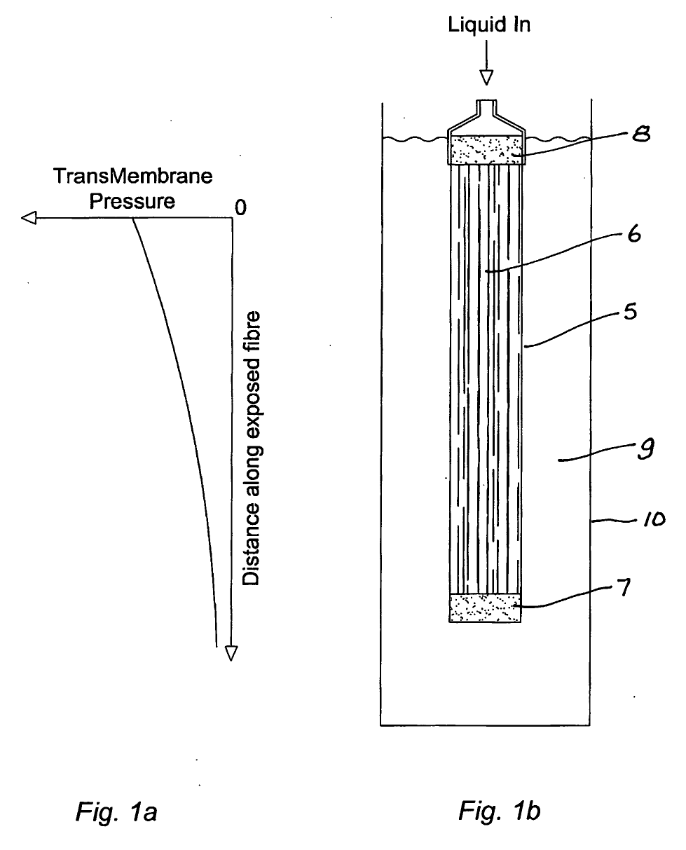

Referring to FIGS. 1a and 1b, the graph shown in FIG. 1a illustrates the change in transmembrane pressure (TMP) as the distance from the application of pressure flow increases. FIG. 1b shows a membrane module 5 having a plurality of hollow fibre membranes 6. The fibre membranes 6 are closed at the lower end in a lower pot 7 and open at the upper end through upper pot 8. The module is immersed in liquid 9 contained in a vessel 10. In the case illustrated, pressurized liquid is applied to the open end of the fibre lumens 11 resulting in the TMP profile shown in FIG. 1a.

As noted above, in membranes with the fibre membranes 6 closed at one end, the pressure of liquid is highest at the point of application of the pressurized flow to the fibres lumens 11 and tapers off along the length of the membrane 6. This results in uneven backwashing and poor recovery of TMP at portions of the fibre membranes 6 remote from the backwash application point.

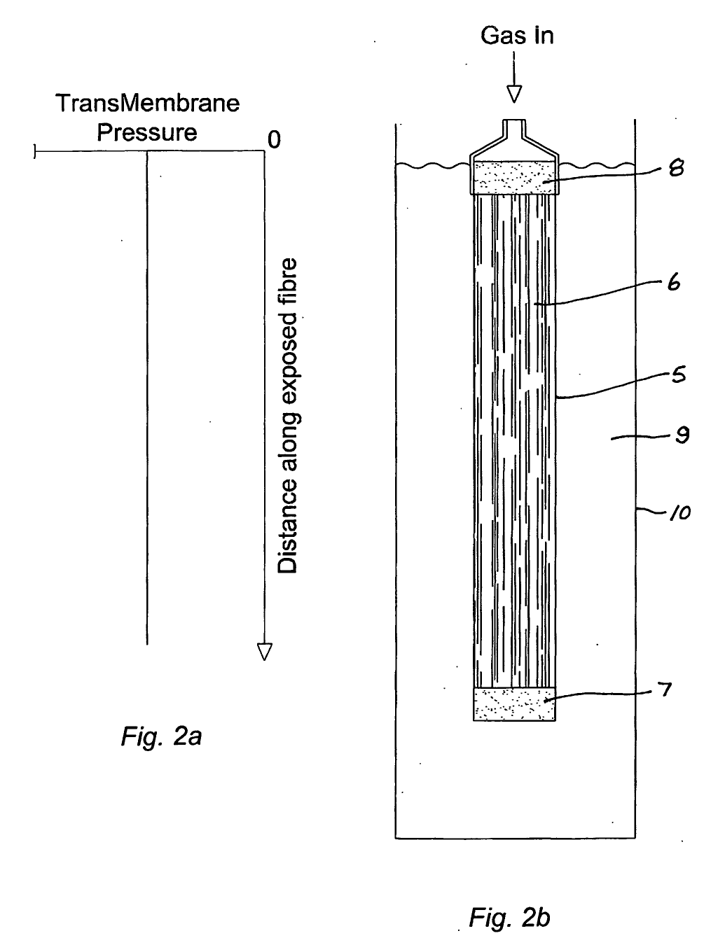

FIGS. 2a and 2b show a similar arrangement to FIG. 1 but in this case pressurized gas is applied to the fibre membrane lumens 11 resulting in an even distribution of TMP along the length of the fibre membranes 6.

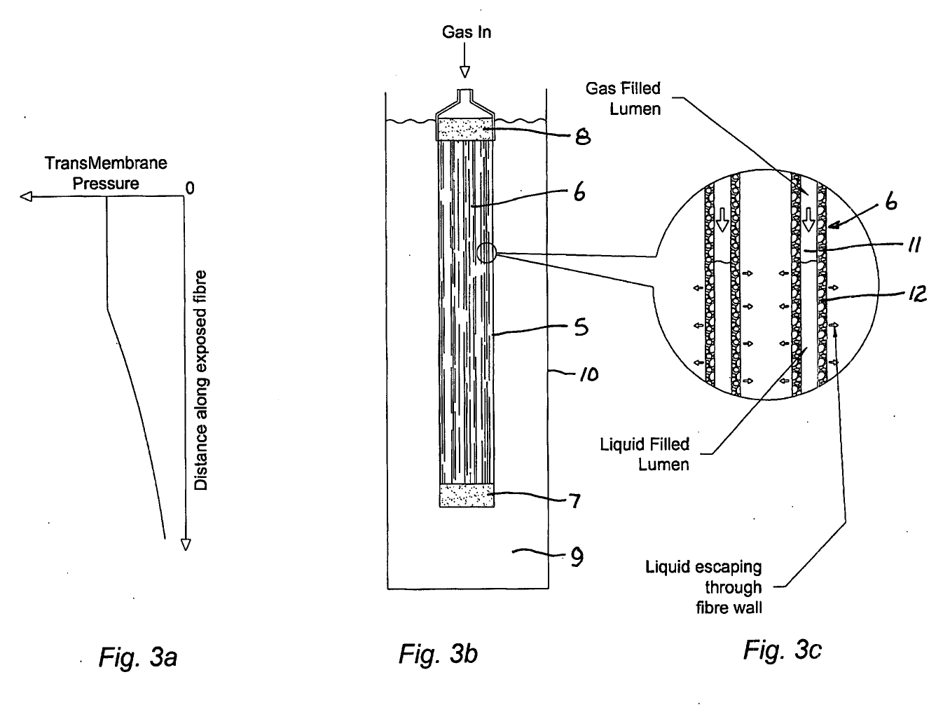

FIGS. 3a to 3c illustrate one embodiment of the invention where pressurized gas is applied at a pressure below the bubble point to liquid filled fibre membrane lumens 11. As best shown in FIG. 3c as the liquid is displaced through the membrane wall 12, the lumen 11 becomes filled with gas resulting in a maximum TMP being applied along the length of the fibre membrane 6 as the liquid level within the fibre membrane lumen 11 drops.

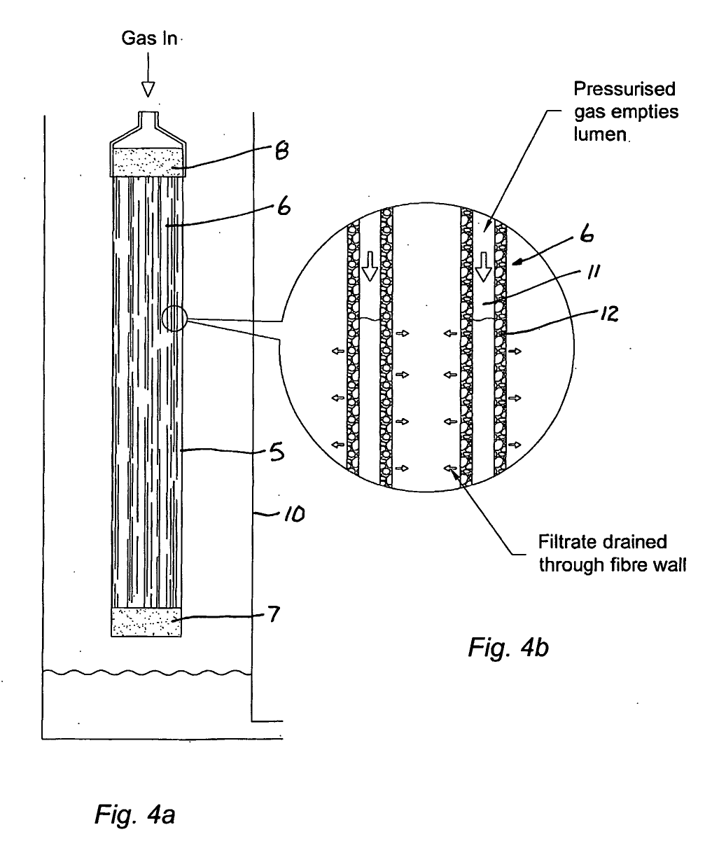

FIGS. 4a and 4b illustrate a further embodiment of the invention where liquid is drained from around the membrane module 5 before the backwashing process is commenced. The backwashing process is similar to that described above for FIG. 3.

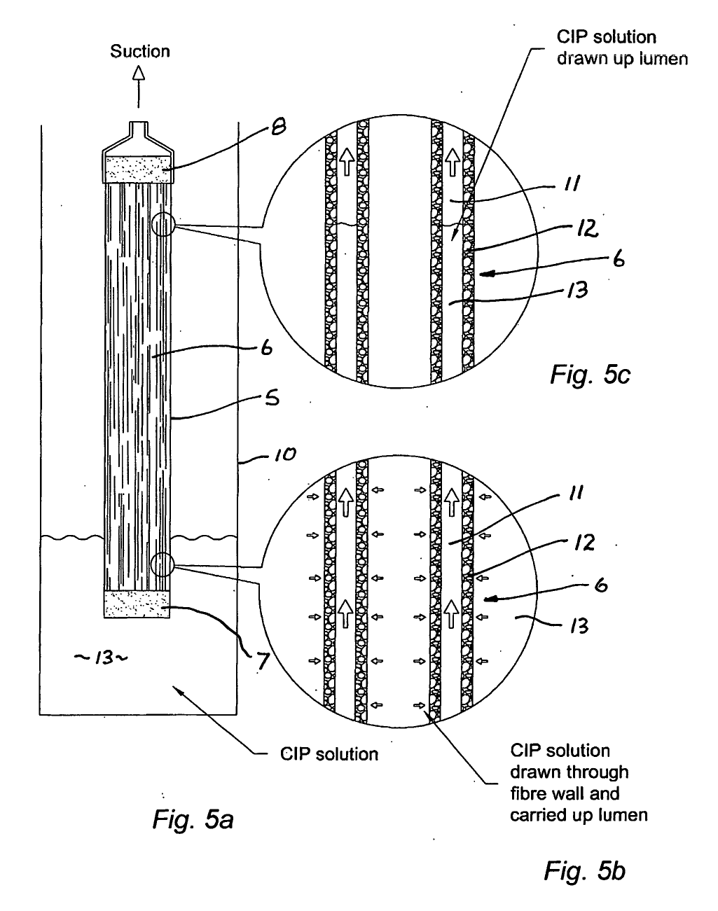

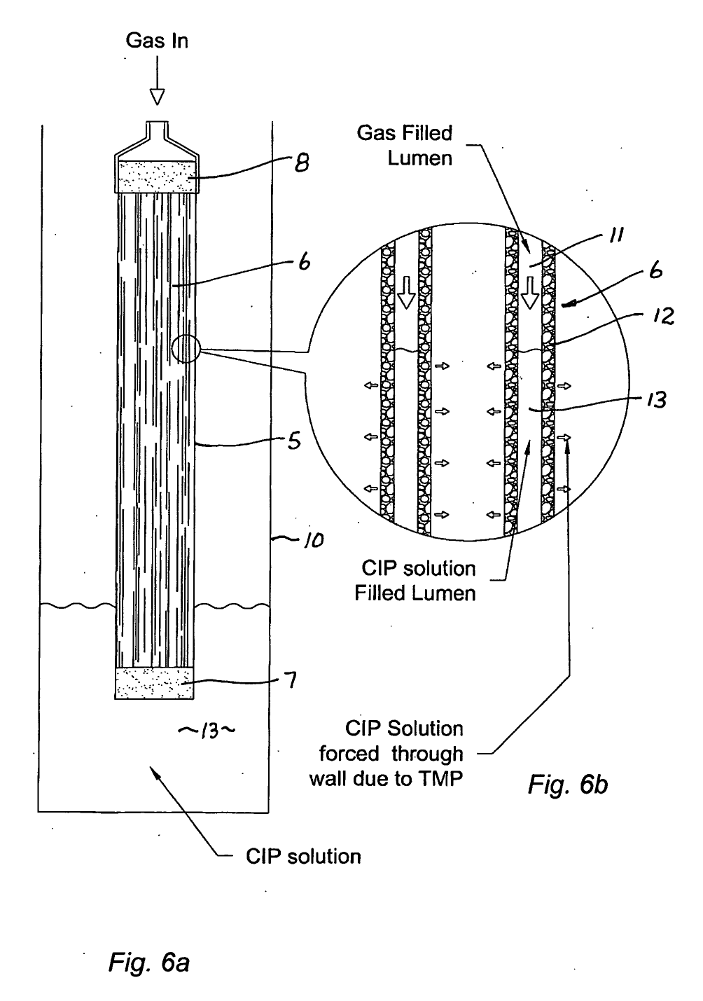

Referring to FIGS. 5 and 6, one embodiment of the cleaning process according to the invention is illustrated. The membrane module 5 is immersed at least partially in chemical cleaning solution 13 and suction is applied to the open ends of the fibre membrane lumens 11. As best shown in FIG. 5b, the cleaning solution 13 is drawn through the membrane wall 12 and into the fibre membrane lumen 11. The cleaning solution 13 is then drawn up through the lumen 11 until it is completely filled as shown in FIG. 5c. As shown in FIGS. 6a and 6b, pressurized gas is then applied to the cleaning solution filling the membrane lumen 11 and displaced through the membrane wall 12 as previously described. This flow of cleaning solution to and from the membrane lumens 11 as well as along their length results in an effective chemical clean of the membrane module 5.

The invention may be embodied in a similar apparatus to that described in the aforementioned International Application No. WO93/02779 appropriately modified to operate in accordance with the inventive method.

It will be appreciated that further embodiments and exemplifications of the invention are possible without departing from the spirit or scope of the invention described.

1. A method of concentrating the solids of a liquid suspension comprising:
(i) providing a pressure differential across the walls of permeable, hollow membranes immersed in the liquid suspension, said liquid suspension being applied to the outer surface of the porous hollow membranes to induce and sustain filtration through the membrane walls wherein:
(a) some of the liquid suspension passes through the walls of the membranes to be drawn off as clarified liquid or filtrate from the hollow membrane lumens, and
(b) at least some of the solids are retained on or in the hollow membranes or otherwise as suspended solids within the liquid surrounding the membranes,
(ii) periodically backwashing the membrane pores using the filtrate by applying a gas at a pressure below the bubble point to the membrane lumens to progressively displace at least some of the liquid filtrate within the lumens through the membrane pores resulting in removal the solids retained on or in the hollow membranes into the bulk liquid surrounding the membranes.

2. A method of concentrating the solids of a liquid suspension comprising:
(i) providing a pressure differential across the walls of permeable, hollow membranes immersed in the liquid suspension, said liquid suspension being applied to the outer surface of the porous hollow membranes to induce and sustain filtration through the membrane walls wherein:
(a) some of the liquid suspension passes through the walls of the membranes to be drawn off as clarified liquid or filtrate from the hollow membrane lumens, and
(b) at least some of the solids are retained on or in the hollow membranes or otherwise as suspended solids within the liquid surrounding the membranes,
(ii) dislodging the retained solids from the membranes by applying a dislodging medium through the lumens of said membranes while concurrently draining liquid from said lumens, wherein the application of the dislodging medium initially displaces liquid within the hollow membrane lumens through the hollow membrane with gas, to effect firstly a discharge of liquid in the lumens through the membrane walls, and secondly a transmembrane cleaning of the membranes by applying the gas at sufficient pressure onto the liquid to overcome the bubble point of the membrane, and ensure that the gas will displace liquid and follow it through the larger pores of the membranes to dislodge any solids retained therein; and for the emerging gas to scour the external walls of the membranes and displace the removed solids into the bulk liquid surrounding the membranes.

3. A method of concentrating the solids of a liquid suspension according to claim 1 wherein said method is carried out as a continuous process utilizing a repetitive cycle of solid accumulation and solid displacement or removal.

4. A method of concentrating the solids of a liquid suspension according to claim 1 wherein the dislodging or backwashing step includes use of a chemical cleaning solution.

5. A method of concentrating the solids of a liquid suspension according to claim 4 including the step of filtering the chemical cleaning solution from the outer surface of the porous hollow membranes into the membrane lumens and then displacing said chemical cleaning solution back through the membrane pores by application of said gas.

6. A method of concentrating the solids of a liquid suspension according to claim 4 wherein the backwashing or dislodging step includes displacing the filtrate in a reverse direction through the membrane pores while injecting chemical cleaning solution into the filtrate.

7. A method of concentrating the solids of a liquid suspension according to claim 4 including the step of applying chemical cleaning solution under pressure to the outer surface of the porous hollow membranes to displace chemical cleaning solution through the membrane pores into the membrane lumens and then displacing said chemical cleaning solution back through the membrane pores by application of said gas.

8. A method according to claim 5 including the step of removing at least part of the liquid remaining in the membrane lumens prior to displacing chemical cleaning solution into the membrane lumens.

9. A method according to claim 5 wherein the displacing of chemical solution into the membrane lumens takes place before said transmembrane cleaning.

10. A method of concentrating the solids of a liquid suspension according to claim 1 wherein the gas is pulsed in its application to the membrane lumens.

11. A method of concentrating the solids of a liquid suspension according to claim 1 including the step of removing at least part of the bulk liquid surrounding the membranes prior to the backwashing or dislodging step.

12. A concentrator for recovering fine solids from a liquid feed suspension comprising:
(i) a vessel for containing said feed suspension;
(ii) a plurality of permeable, hollow membranes within the vessel;
(iii) means for providing a pressure differential across walls of said membranes;
(iv) means for withdrawing clarified liquid from the membrane; and
(v) means for applying gas at a pressure below the bubble point to the liquid permeate in the membrane lumens to effect a discharge of at least some of the liquid permeate in the lumens through the membrane walls to dislodge any solids retained therein and displace the removed solids into the bulk liquid surrounding the membranes.

13. A concentrator for recovering fine solids from a liquid feed suspension comprising:
(i) a vessel or tank for containing said feed suspension;
(ii) a plurality of permeable, hollow membranes within the vessel or tank;
(iii) means for providing a pressure differential across walls of said membranes;
(iv) means for withdrawing clarified liquid from the membrane; and
(v) means for applying gas pressure to the liquid in the membrane lumens and walls while the vessel or tank is exposed to atmospheric pressure and while concurrently draining liquid from said lumens, to effect firstly a discharge of liquid in the lumens through the membrane walls, and secondly a transmembrane cleaning of the membranes by applying the gas at sufficient pressure onto the liquid to overcome the bubble point of the membrane, and ensure that the gas will displace liquid and follow it through the larger pores of the membranes to dislodge any solids retained therein; and for the emerging gas to scour the external walls of the membranes and displace the removed solids into the bulk liquid in the vessel or tank.
